(19) United States
(12) Patent Application Publication
(10) Pub. No.: US 2023/0252328 A1
(43) Pub. Date: Aug. 10, 2023

(54) SCHEDULING OF INFERENCE MODELS BASED ON PREEMPTABLE BOUNDARIES

(71) Applicant: TEXAS INSTRUMENTS INCORPORATED, Dallas, TX (US)

(72) Inventors: Pramod Swami, Bangalore (IN); Eppa Praveen Reddy, Sangareddy (IN); Jesse Villarreal, Richardson, TX (US); Kumar Desappan, Bengaluru (IN)

(21) Appl. No.: 18/153,764

(22) Filed: Jan. 12, 2023

Related U.S. Application Data
(60) Provisional application No. 63/298,770, filed on Jan. 12, 2022.

(51) Int. Cl. G06N 5/048; G06F 9/48

(52) U.S. Cl. CPC G06N 5/048; G06F 9/4818

(57) ABSTRACT

Disclosed herein are systems and methods for inference model scheduling of a multi priority inference model system. A processor determines an interrupt flag has been set indicative of a request to interrupt execution of a first inference model in favor of a second inference model. In response to determining that the interrupt flag has been set, the processor determines a state of the execution of the first inference model based on one or more factors. In response to determining the state of the execution is at a preemptable boundary, the processor deactivates the first inference model and activates the second inference model.

### RELATED APPLICATIONS

This application is related to, and claims the benefit of priority to, U.S. Provisional Patent Application No. 63/298,770, filed on Jan. 12, 2022, and entitled “Methods for Optimal Scheduling of Multi Priority DNNs,” which is hereby incorporated by reference in its entirety.

### TECHNICAL FIELD

Aspects of the disclosure are related to the field of computing hardware and software and, in particular, to technology for the scheduling of inference models in embedded systems.

### BACKGROUND

Deep neural networks (DNNs) represent a method of machine learning that use interconnected nodes in a layered structure to perform designated tasks. Examples of DNNs include artificial neural networks (ANNs), convolution neural networks (CNNs), recurrent neural networks (RNNs), and other such inference models. Inference models may be employed in embedded systems to, for example, detect objects, classify images, process text, and so on. Embedded systems are found in automotive environments, industrial environments, and other execution environments.

In environments where multiple inference models are deployed for various purposes, a scheduler balances system priorities by activating and deactivating inference models on a resource based on runtime conditions. For example, the scheduler may deactivate a lower-priority inference model executing on a thread in favor of a higher-priority model in response to input from a sensor corresponding to the higher-priority inference model. Once the higher-priority model has completed its execution, the scheduler may restart the lower-priority model.

Unfortunately, the process of deactivating the lower priority inference model (and later re-activating it) takes time and consumes valuable resources such as memory and processing cycles. For instance, when one inference model is deactivated in favor of another, the context for the deactivated model must be saved to memory, thereby reducing the amount of memory available to other processes. This is especially true when an inference model is preempted at the completion of a layer that has a very large context size.

### SUMMARY

Technology is disclosed herein that provides for the pre-emption and resumption of inference models at optimal boundaries, resulting in non-limiting performance improvements such as increased speed and memory conservation. Various implementations include a computer-implemented method for inference model scheduling of a multi priority inference model system. Processing circuitry of a suitable computer determines that an interrupt flag has been set. The interrupt flag is indicative of a request to interrupt execution of a lower priority inference model in favor of a higher priority inference model. In response to determining the interrupt flag has been set, the processing circuitry determines a state of the execution of the lower priority inference model based one or more factors. In response to determining the state of the execution is at a preemptable boundary, the processing circuitry deactivates the lower priority inference model and activates the higher priority inference model.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment, according to some embodiments.

FIG. 2 illustrates a scheduling process according to some embodiments.

FIG. 3 illustrates an operational sequence according to some embodiments.

FIG. 4 illustrates an operational scenario according to some embodiments.

FIG. 5 illustrates a boundary identification process according to some embodiments.

FIGS. 6A-6D illustrate a visualization of the boundary identification process of FIG. 5 according to some embodiments.

FIG. 7 illustrates a computing system suitable for implementing the various operational environments, architectures, processes, scenarios, and sequences discussed below with respect to the other Figures.

### DETAILED DESCRIPTION

Various implementations are disclosed herein that describe systems and methods to schedule inference model execution of a multi priority inference model system. In various implementations, processing circuitry described herein may be configured to determine an interrupt flag has been set indicative of a request to interrupt execution of a first inference model executing on a resource in favor of a second, higher-priority inference model. In an implementation, interrupt flags are generated by a sensor interface (or any other type of data input interface) and are representative of a detected input. Interrupt flags generated by the sensor interface are delivered to the processing circuitry to trigger the execution of a respective inference model.

In response to determining the interrupt flag has been set, the processing circuitry determines a state of the execution of the first inference model currently executing on the resource, based on one or more factors. In some embodiments, the one or more factors include whether the execution of first inference model will reach a preemptable boundary within an allowable breathing time. Preemptable boundaries describe points between executable layers of an inference model where a minimal amount of data is needed to be stored off-chip when one model is preempted by another, while breathing times describe an allowable amount of time that can pass once input data has arrived for a given inference model. For instance, the allowable breathing time may be derived from a tolerable latency of the second inference model, as well as an execution time of the second inference model. The breathing time is, for example, the difference between the tolerable latency and the execution time of the second inference model. Once data has been received for the second inference model, the second inference model must be started within the allowable breathing time (assuming it is higher priority than the first model). As such, the breathing time is amount of time the first inference model can continue to execute before it must be interrupted in favor of the second inference model.

Accordingly, if the state of the first inference model is such that it will reach a preemptable boundary within its allotted breathing time, then the processing circuitry will wait to take action with respect to the interrupt flag until the first model has reached the preemptable boundary. In the ensuing time, the first inference model may continue its execution through one or more layers until it reaches the preemptable boundary. (In some cases, the breathing time may even be sufficient to allow the first inference model to pass through one preemptable boundary to a subsequent preemptable boundary.) However, if the state of the first inference model is such that it will not reach a preemptable boundary within the allotted breathing time, then the processing circuitry will preempt the first inference model in favor of the second inference model, to ensure that the second inference model is able to complete its processing within its tolerable latency. In some embodiments, the processing circuitry may re-activate the first inference model on the resource after the completion of the second inference model.

In various implementations, a suitable computing system employs a boundary identification process to identify the preemptable boundaries of inference models. The boundary identification process is implemented in program instructions in the context of software stored on and executed by components of the computing system. The software directs the computing system to detect preemptable boundaries between executable layers of every inference model within the multi priority inference model system based on performance characteristics of each of the multiple of the layers of a given inference model. For example, the performance characteristics of each of the multiple layers may include a context size and a processing time of each of the multiple layers. Other characteristics factored into the determination of preemptable boundaries include the breathing time(s) associated with the model. As mentioned, the breathing time for a given inference model relates to the difference between the tolerable latency and execution time of any other inference models that are of a higher priority relative to the inference model for which preemptable boundaries are sought.

The preemptable boundaries describe optimal points at which an inference engine may preempt an executing inference model, such that a higher priority non-executing inference model can begin its execution. Preemptable boundaries exist between executable layers of an inference model and are determined based on a set of layer statistics. For example, layer statistics may include the on-chip memory requirement of each layer, and the network execution time of each layer. In an implementation, the computing system gathers layer statistics from memory related to every layer of every inference model within a multi priority inference model system. From the collected layer statistics, the computing system identifies the allowable preemptable boundaries by determining, when preempted, which layers of the inference model require a minimal amount of space within on-chip memory. In some scenarios, layer statistics may vary (or drift) over time. Thus, the process of identifying preemptable boundaries may be employed at runtime or under near-runtime conditions.

Additionally, a computing system executing the boundary identification process determines a breathing time of the multi priority inference model system. In an implementation, the computing system determines the breathing time based on data of the highest priority inference model that has yet to be executed within the multi priority inference model system. More specifically, the breathing time is defined as the difference between the tolerable latency and the execution time of a higher priority inference model within the multi priority system.

It may be appreciated that the boundary identification process may be employed offline with respect to the embedded environments in which the identified boundaries are deployed. However, the breathing time(s) of a multi priority inference model system may change dynamically over time, dependent on which inference models have already been executed. As such, the boundary identification process may also be employed in runtime environments to update the breathing time(s) identified for the system.

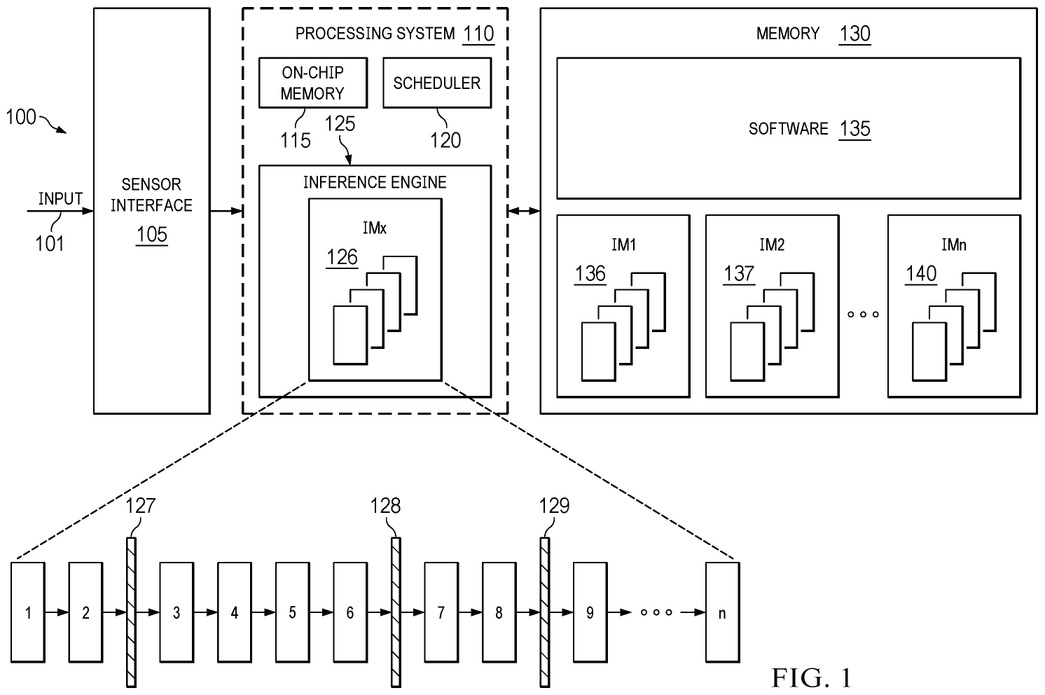

Referring now to the drawings, FIG. 1 illustrates an operational environment in an embodiment, herein referred to as operational environment 100. Operational environment 100 includes sensor interface 105, processing system 110, and memory 130. Operational environment 100 may be implemented in a larger context, such as, for example a vehicle with a vision system, or any other system that may utilize computer vision. In some embodiments, operational environment 100 may be implemented in a computing system, such as, for example, a cloud-based system that offers cloud-based services to schedule inference model execution.

Processing system 110 represents computing hardware, firmware, or a combination thereof that includes processing circuitry capable of executing program instructions to implement the method of inference model scheduling of a multi priority inference model system. Processing system 110 includes—but is not limited to—on-chip memory 115, scheduler 120, and inference engine 125. Processing system 110 may be implemented within a single processing device but may also be distributed across multiple processing devices or sub-systems that cooperate in executing program instructions. Examples of processing system 110 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof.

Processing system 110 loads and executes program instructions from memory 130 including software 135 and inference models 136-140. Inference model 136, inference model 137, and inference model 140 are representative of a multi priority inference model system. Software 135 includes program instructions that, when executed by processing system 110, implement scheduler 120 and inference engine 125. Memory 130 represents any type of memory such as volatile and nonvolatile, removable and non-removable memory implemented in any method or technology for storage of information, such as computer readable instructions, data structures, program modules, memory, or other data. Examples of memory 130 include random access memory (RAM), read only memory (ROM), programmable ROM, erasable programmable ROM, electronically erasable programmable ROM, solid-state drives, magnetic disks, optical disks, optical media, flash memory, virtual memory and non-virtual memory, magnetic cassettes, magnetic tape, magnetic disk storage or other magnetic storage devices, or any other suitable storage media. In no case is memory 130 a propagated signal.

On-chip memory 115 represents integrated on processing system 110. On-chip memory 115 serves as fast access memory for inference engine 125 and is logically coupled to scheduler 120 and inference engine 125 to store data related to the method of inference model scheduling. For example, on-chip memory 115 stores context data of an ongoing (currently executing) inference model. When the inference model is preempted, its context data is offloaded to memory 130. When the same inference model is later reactivated, its context data is reloaded from memory 130 to on-chip memory 115. On-chip memory 115 may store other data that is not included here for ease of description.

Processing system 110 is also operatively coupled to sensor interface 105. Sensor interface 105 represents any system that includes a variety of sensors configured to receive, capture, and/or create an input signal that triggers the execution of a respective inference model. For example, sensor interface 105 may connect to a sensor sub-system that includes a variety of cameras equipped to capture input 101 as video, images, or both. Other sensors include but are not limited to position sensors, temperature sensors, pressure sensors, or sensors of the like. In some embodiments sensor interface 105 may be a receiving component for a cloud-based service that requires inference model scheduling. Sensor interface 105 is embodied as a single component, but any number of sensors, receivers, or other components may be included across operational environment 100 that provide input to a respective inference model.

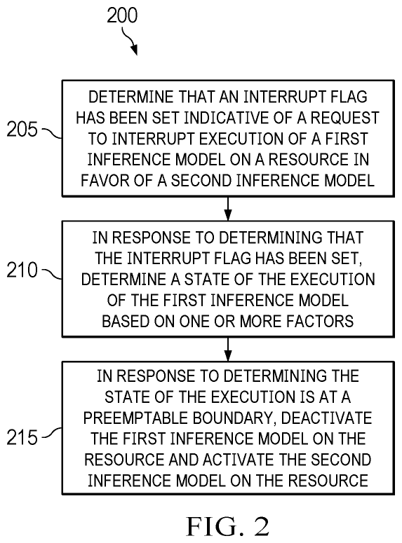

Scheduler 120 represents software or firmware employed by processing system 110 to manage the execution of inference models. Processing system 110 employs scheduler 120 to perform a method of inference model scheduling illustrated in FIG. 2. Scheduler 120 is logically coupled to inference engine 125 to perform the method of inference model scheduling. For example, scheduler 120 generates activation and deactivation commands for inference engine 125. Activation commands instruct inference engine 125 to either begin execution of an inference model or resume execution of a previously preempted inference model. Deactivation commands instruct inference engine 125 to preempt a currently executing inference model.

Inference engine 125 represents software and/or firmware employed by processing system 110 to execute inference models. Inference engine 125 is an example of a resource on which inference model 126 can be executed. Processing system 110 employs inference engine 125 to execute inference models within the multi priority inference model system. Inference engine 125 is stored in software 135 of memory 130. Inference engine 125 is logically coupled to scheduler 120 and on-chip memory 115 and executes inference models of the multi priority inference model system as directed by scheduler 120. Scheduler 120 directs inference engine 125 to activate an inference model, deactivate an executing inference model, or re-active a previously deactivated inference model. In response, inference engine 125 executes an inference model, preempts an executing inference model, and/or resumes execution of a previously preempted inference model respectively. Inference engine 125 stores data of a preempted inference model in memory 130. When instructed by scheduler 120, inference engine 125 reloads the preempted data from memory 130 to on-chip memory 115 and resumes execution of the previously preempted model. Additional example details of neural networks can be found in commonly assigned U.S. patent application Publication Ser. No. 17/463,341, entitled “Reconfigurable Execution of Machine Learning Networks,” filed on Aug. 31, 2021, which is incorporated by reference in its entirety.

In a brief operational scenario, processing system 110 loads inference model 126 from memory 130 to inference engine 125 in response to a detected input. Inference engine 125 begins execution of inference model 126 until instructed otherwise. Inference model 126 represents an executing inference model loaded from memory 130. For example, inference model 126 represents any one of inference model 136, inference model 137, inference model 140, which itself represents an n^{th} inference model. Inference model 126 includes preemptable boundaries 127, 128, and 129. Preemptable boundaries 127, 128, and 129 represent optimal boundaries between layers of inference model 126 where context size is minimal relative to layer boundaries of the model. When inference model 126 is preempted, inference engine 125 offloads the context of inference model 126 from on-chip memory 115 to memory 130. When re-activated, inference engine 125 reloads the context data from memory 130 to on-chip memory 115. Inference engine 125 then resumes execution of inference model 126 at the layer following the boundary in which it was preempted.

FIG. 2 illustrates a scheduling process 200 in an embodiment that represents a method for scheduling the execution of inference models in a multi-priority environment. Scheduling process 200 may be employed by processing system 110 (or any embedded system) in the context of scheduler 120. Scheduling process 200 may be implemented in program instructions that, when executed by a suitable processing system, direct the processing system to operate as follows, referring parenthetically to the steps in FIG. 2.

To begin, the processing system determines that an interrupt flag has been set indicative of a request to interrupt execution of a first inference model on a resource in favor of a second, higher-priority inference model (step 205). For example, the interrupt flag may be generated by a sensor interface (e.g., sensor interface 105). The sensor interface generates an interrupt flag upon detecting input related to a corresponding inference model.

In response to determining the interrupt flag has been set, the processing system determines a state of the execution of the first inference model based on one or more factors (step 210). Example factors include the current layer at which the first inference model is executing as well as a breathing time associated with the first inference model (and derived from aspects of the second inference model). In response to determining that the state of the execution is at a preemptable boundary, the processing system deactivates the first inference model and activates the second inference model (Step 215).

In some scenarios, if the state of the first inference model is such that the model will reach a preemptable boundary within its allotted breathing time, then the processing system ignores the interrupt flag until the first model has reached the preemptable boundary. As mentioned above, in the ensuing time the first inference model may continue its execution through one or more layers until it reaches the preemptable boundary. However, if the state of the first inference model is such that it will not reach a preemptable boundary within the allotted breathing time, then the processing system preempts the first inference model in favor of the second inference model, to ensure that the second inference model is able to complete its processing within its tolerable latency. In some embodiments, the processing systems may re-activate the first inference model after the completion of the second inference model.

Referring back to FIG. 1, the following describes a brief example of scheduling process 200 applied in the context of operational environment 100. In operation, inference engine 125 executes a first inference model, as represented by inference model 126. During execution of the first inference model, sensor interface 105 detects input 101 and generates a corresponding interrupt flag. Processing system 110 receives the corresponding interrupt flag, which is indicative of a request to interrupt execution of the first inference model in favor of a second, higher-priority inference model.

In response to determining the interrupt flag has been set, processing system 110 employs scheduler 120 to determine when to preempt the first inference model in favor of the second model. The determination is based on one or more factors including how far along in its processing chain (layers) the first inference model has gone, as well as what the breathing time is for the first model with respect to the second model. For example, inference model 126 may have reached layer 5, meaning that two preemptable boundaries remain in the chain. Scheduler 120 may determine to preempt inference model 126 immediately if insufficient breathing time exists to continue executing until one of the preemptable boundaries is reach. However, it may be the case that the breathing time provides sufficient time for schedule 120 wait for inference model 126 to reach one or the other preemptable boundaries. Assuming so, schedule 120 waits for inference model 126 to reach the preemptable boundary before interacting with inference engine 125 to deactivate inference model 126 activate the higher-priority inference model.

When instructed by scheduler 120, inference engine 125 preempts execution of the first inference model and offloads its context data from on-chip memory 115 to memory 130. Inference engine 125 then loads the second inference model to begin execution. In an implementation, scheduler 120 re-activates the first inference model upon completion of the second inference model and, in support of the reactivation, reloads its context data from memory 130 to on-chip memory 115.

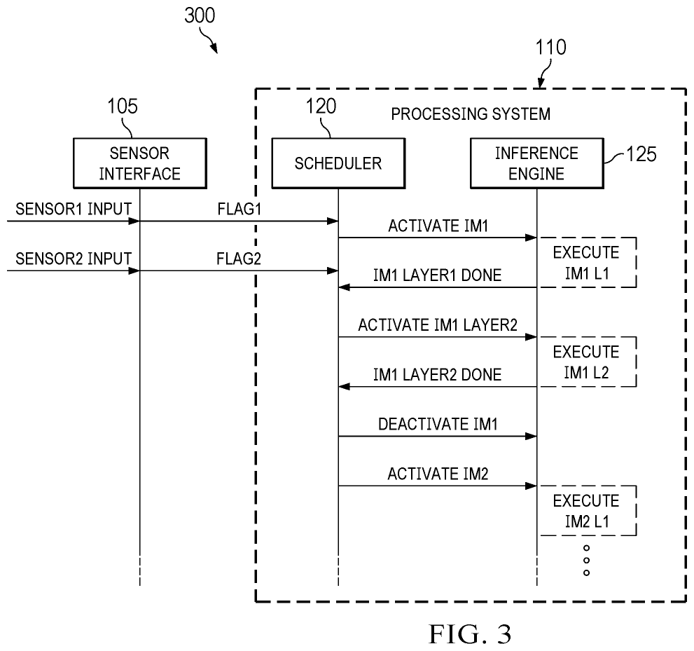

FIG. 3 is an operational sequence 300 illustrating an application of scheduling process 200 in the context of operational environment 100. Operational sequence 300 demonstrates how the components of operational environment 100 communicate or otherwise interact at run-time. Operational sequence 300 involves but is not limited to, sensor interface 105, processing system 110, scheduler 120, and inference engine 125.

In operational sequence 300, processing system 110 executes scheduling process 200 in the context of scheduler 120 and inference engine 125. Sensor interface 105 receives sensor data, representative of a data produced by a first sensor. In response, sensor interface 105 generates interrupt flag indicating that the data has arrived. Sensor interface 105 sends the interrupt flag to processing system 110 to begin execution of a first inference model that utilizes the sensor data as input.

Upon receiving the interrupt flag, processing system 110 examines the execution state of inference engine 125 to determine whether inference engine 125 is actively executing an inference model. As no other inference models are currently being executed, processing system 110 instructs scheduler 120 to generate an activation command. Scheduler 120 sends an activation command to inference engine 125 to begin executing a first layer of the first inference model. Once executed, inference engine 125 returns a signal to scheduler 120 indicative of the completion of the first layer.

During execution of the first layer, it is assumed that sensor interface 105 receives sensor data associated with a second sensor. In response, sensor interface 105 generates an interrupt flag for processing system 110 indicating that data has been produced by the second sensor. It is assumed for exemplary purposes that the input detected by the second sensor relates to a higher priority inference model, as compared to the input detected by the first sensor.

Upon receiving the second interrupt flag, processing system 110 examines the state of inference engine 125. Currently, inference engine 125 is executing the first (lower priority) inference model. As such, processing system 110 determines whether the first inference model can complete its execution and/or reach a preemptable boundary within its execution within an allotted breathing time. If not, then processing system 110 immediately preempts the first inference model in favor of the second inference model. However, if the breathing time is sufficient to allow the first inference model to continue executing until it reaches a preemptable boundary, then processing system 110 allows it to do so until it reaches the boundary.

Here, it is assumed for exemplary purposes that the interrupt flag is received when the first inference model is executing its first layer. Inference engine 125 checks with scheduler 120 at the completion of the first layer to obtain its next instruction. Scheduler 120 has determined that the breathing time is sufficient to allow the first inference engine to continue running. Accordingly, scheduler 120 instructs inference engine 125 to continue executing the first inference model.

Inference engine 125 continues to execute the first inference model. When the first inference model completes its second layer, inference engine 125 again checks with scheduler 120. At this point, scheduler 120 determines to deactivate the first inference model in favor of the second inference model at the completion of the second layer, which is assumed for exemplary purposes to be at a preemptable boundary. This is because there is no longer sufficient time to remaining to reach a next preemptable boundary (or to complete its execution altogether) without exceeding the allowable breathing time.

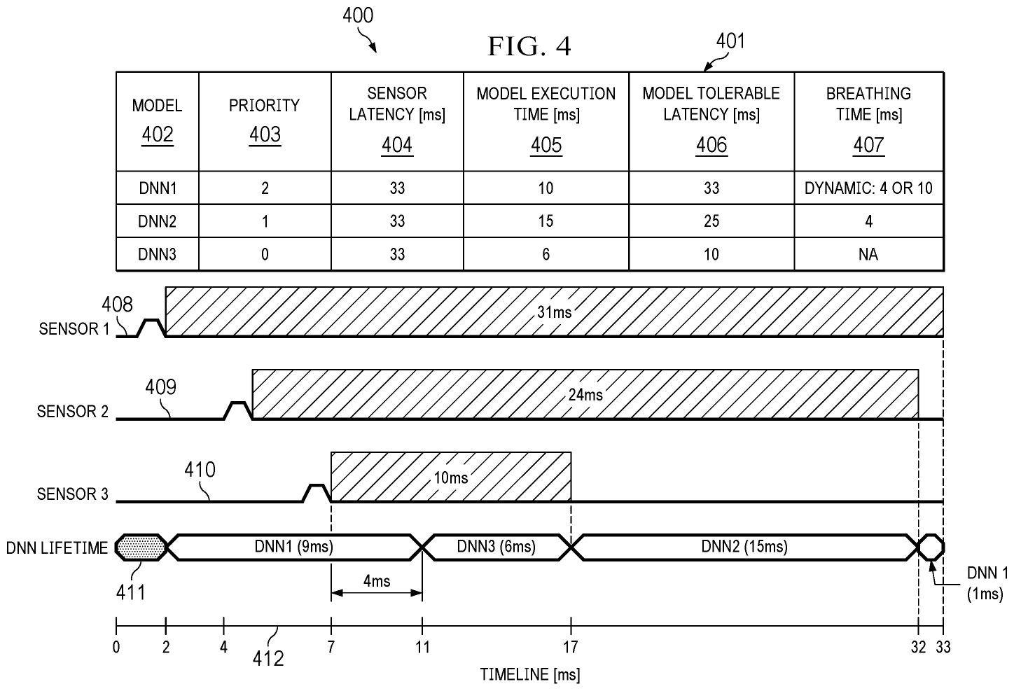

FIG. 4 illustrates a timing diagram that depicts another application of scheduling process 200 employed by a scheduler in the context of an embedded system, herein referred to as timing diagram 400. The embedded system is assumed for exemplary purposes to include three deep neural networks (DNNs) represented by DNN-1, DNN-2, and DNN-3. The scheduler, implemented in hardware, firmware, and/or software in the embedded system, activates and deactivates the models in response to inputs provided by sensor-1, sensor-2, and sensor-3.

Timing diagram 400 includes table 401, which includes information characteristic of each DNN. For example, table 401 includes model column 402, priority column 403, sensor latency column 404, model execution time column 405, model tolerable latency column 406, and breathing time column 407. Table 401 also includes three rows, each corresponding to a different one of DNN-1, DNN-2, and DNN-3 listed in model column 402. At the intersection of each column and row, table 401 stores a value representative of a specific characteristic for each DNN. For example, the first row of table 401 stores the priority, sensor latency, execution time, tolerable latency time, and breathing time for DNN-1. Likewise, the second and third rows store the same values for DNN-2 and DNN-3 respectively.

The values in table 401 are used by the scheduler to determine whether and when to preempt a given DNN. For instance, data from priority column 403, model execution time column 405, and model tolerable latency column 406, allow the processor to determine a corresponding breathing time for each DNN within the multi priority DNN system. Priority column 403 indicates the priority of each DNN within the system such that the highest priority is represented as 0. In this example illustration, DNN-3 is the highest priority model, DNN-2 is the next highest priority model, and DNN-1 is the lowest priority model.

Model execution time column 405 indicates the time required to execute each DNN within the multi priority DNN system. Model tolerable latency column 406 indicates the maximum amount of time that is allowed to elapse from the moment data arrives for a given model. More specifically, model tolerable latency column 406 depicts the allotted time an input must be processed by its respective DNN. Input that is not processed within the tolerable latency of its respective DNN is no longer viable for processing. For instance, while DNN3 requires 6 ms to execute, it has a tolerable latency of 10 ms, meaning that it can wait 4 ms between when data arrives and when it must start processing the data. The difference between the tolerable latency and execution time of a respective DNN is represented in the breathing time figures of breathing time column 407. Sensor latency column 404 holds values that represent a latency of the sensors within the system.

Timing diagram 400 also includes timeline 412, which represents the elapsed time of the system which respect to which all lines and lifelines are illustrated. Lines 408, 409, and 410 of timing diagram 400 depict graphical representations of the states of various sensors in the embedded system, represented by sensor-1, sensor-2, and sensor-3. Line 408 represents that state of sensor-1, line 409 represents the state of sensor-2, and line 410 represents the state of sensor-3. The sensors output data which triggers the scheduler to execute a corresponding one of the models. Line 408 depicts when sensor-1 outputs data, while line 409 depicts when sensor-2 outputs data, and line 410 depicts when sensor-3 outputs data.

Lifeline 411 represents the state of a resource in the embedded system that executes the models. An example resource is a thread in multi-thread processing environment that executes one DNN at a time. The scheduler activates and deactivates the models on the thread per the scheduling techniques disclosed herein. Lifeline 411 depicts which model is executing on the thread at any given time.

In operation, the scheduler monitors for data to arrive from any of the sensors. Sensor-1 produces data at time=2, causing the scheduler to determine if DNN-1 may be activated. As no other DNN is currently being executed, the scheduler instructs an inference engine to load and execute DNN-1 on the thread. As shown in table 401, DNN-1 takes 10 ms to complete its execution, and its completion must occur within the tolerable latency of DNN-1. Further, as shown in model tolerable latency column 406, DNN-1 must complete its execution within 33 ms. Failure to do so results in the expiration of the received input.

During the execution of DNN-1, sensor-2 produces data at 4 ms. The scheduler detects that sensor-2 has produced data and determines whether to preempt DNN-1 in favor of DNN-2, since DNN-2 has a higher priority than DNN-1. However, DNN-1 has an allowable breathing time of 10 ms with respect to DNN2. Since DNN-1 takes 10 ms to execute and has already reached 4 ms, the scheduler knows that DNN-1 can complete its execution within the allowable breathing time. Accordingly, the scheduler determines to continue with the execution of DNN-1 rather than preempting it in favor of DNN-2.

At time t=7 ms, while DNN-1 is still executing, data arrives from sensor-3. Data from sensor-3 triggers an interrupt request on behalf of DNN-3. As DNN-3 is a higher priority inference model than DNN-1, the scheduler determines whether and/or when to interrupt DNN-1 based on the allowable breathing time for DNN-1 with respect to DNN-3. Here, the allowable breathing time is only 4 ms (as opposed to 10 ms with respect to DNN-2). In addition, the scheduler determines when DNN-1 will reach its next preemptable boundary. It is assumed for exemplary purposes that DNN-1 will reach its next preemptable boundary at t=11 ms, which is within the allowable breathing time allotted to DNN-1 with respect to DNN-3. The scheduler therefore allows DNN-1 to continue executing until it reaches the preemptable boundary, at which time it preempts DNN-1 in favor of DNN-3, which occurs at t=11 ms.

Continuing with the exemplary scenario, DNN-3 takes 6 ms to complete its executing, during which it is not preempted because it is the highest priority model in the system. DNN-3 completes its execution at 17 ms, at which point the scheduler determines whether to restart DNN-1 or start DNN-2. Scheduler determines to start DNN-2 rather than restart DNN-1 because DNN-2 is a higher priority model than DNN-1. DNN-2 requires 15 ms to execute, at the completion of which the scheduler restarts DNN-1. DNN-1 needs only one more millisecond to complete its execution, bringing the total execution time of DNN-1 to 31 ms, which is within the tolerable latency of 33 ms.

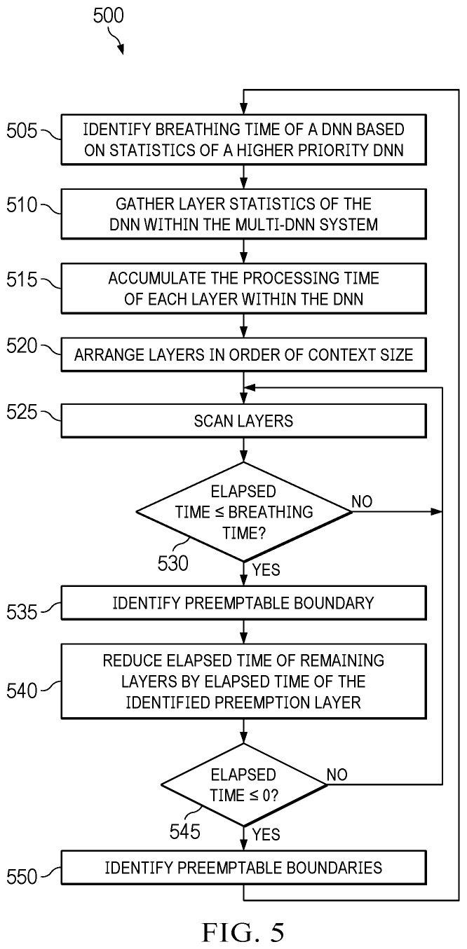

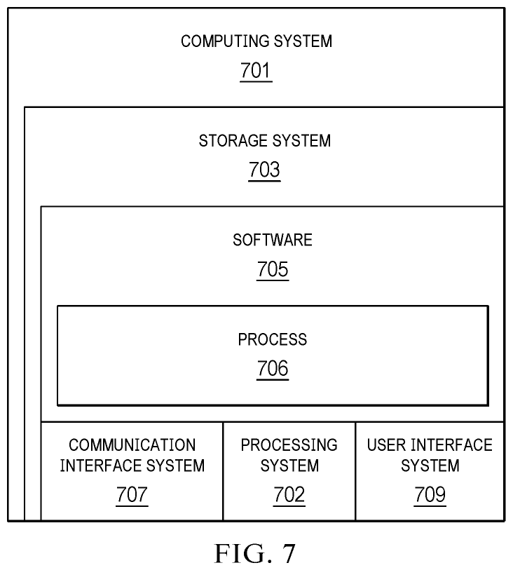

FIG. 5 illustrates a flowchart describing a method to identify preemptable boundaries within a multi priority DNN system, herein referred to as boundary identification process 500. Boundary identification process 500 is employed by a suitable computing system of which computing system 701 in FIG. 7 is representative. Boundary identification process 500 may be performed offline and outside of the context of an embedded system. However, in some implementations, boundary identification process 500 is performed within the context of the same embedded system that ultimately employs the identified boundaries.

Preemptable boundaries describe points between layers of an executing DNN where a processor is allowed to preempt execution. Boundary identification process 500 may be implemented in program instructions, stored in memory (e.g., memory 130) that, when executed by a processor of suitable computing device, direct the computing device to operate as follows, referring parenthetically to the steps of FIG. 5.

To being, the computing device identifies a breathing time of target DNN based on characteristics of a higher priority DNN within the multi priority DNN system (step 505). The breathing time relates to the difference between the tolerable latency time and the execution time of the higher priority DNN within the multi priority DNN system. Next, the computing device gathers layer statistics related to the target DNN within the multi priority DNN system (step 510). The layer statistics include the layer number, the context size, and the processing time of each layer within the target DNN for which preemptable boundaries are sought, which allow the computing device to identify all layers available for preemption.

Next, the computing device accumulates the processing time of each layer of the target DNN to determine how long it takes to sequentially execute each layer (step 515). In other words, the computing device determines an elapsed time of each layer within the target DNN, such that the elapsed time of a layer accounts for the time taken to execute previous layers. Layers of the target DNN are organized by their layer number. Thus, sequentially summing the processing time of each layer allows the processor to determine the execution time of the target DNN.

At step 520, the computing device rearranges the layers based on the context size of each layer. For example, the computing device organizes the layers from smallest to largest context size. Prior to step 520, layers were organized based on their layer number. After step 520, layers are organized based on their context size. It should be noted that, the reorganization of the layers does not affect the previously calculated elapsed time of step 515.

At step 525, the computing device scans the reordered layers to determine the preemptable boundaries of the target DNN. The computing device may iteratively scan the target DNN to identify preemptable boundaries. For example, in a first iteration, the computing device scans the first layer of the target DNN such that the first layer has the smallest context size.

At step 530, the computing device determines whether the elapsed time to execute the first layer is greater than, less than, or equal to the breathing time of system determined at step 505. If the elapsed time of the first layer is greater than the breathing time of the multi priority DNN system (no branch), then the computing device returns to step 525 such that it can scan the next layer of the target DNN. This iterative process is continued until the computing device identifies a layer of the target DNN that has an elapsed time that is less than or equal to the calculated breathing time of the multi priority DNN system (yes branch).

At step 535, the computing device identifies a preemptable boundary to exist after the layer with an elapsed time that is less than or equal to the breathing time of the multi priority DNN system. In runtime, preemption of the target DNN occurs at the preemptable boundary.

At step 540, the computing device reduces the elapsed time of the remaining layers by the elapsed time of the previously identified layer of step 535. For example, if the identified layer had an elapsed time of 20 μs, then the remaining layers elapsed time would be reduced by 20 μs. Remaining layers with an elapsed time less than 20 μs would generate a negative result.

At step 545, the computing device determines if the elapsed time of the remaining layers is less than or equal to zero. If any of the remaining layers have an elapsed time greater than zero (no branch), the computing device returns to step 525 to rescan the remaining layers. This iterative process is repeated until each layer of the target DNN has an elapsed time less than or equal to zero (yes branch).

At step 550, the computing device has determined the preemptable boundaries of the target DNN. Next, the computing device returns to step 505 such that the computing device can identify preemptable boundaries of a next DNN within the multi priority DNN system. Boundary identification process 500 is repeated for every DNN within the multi priority DNN system. As mentioned, boundary identification process 500 may be performed offline with respect to the embedded system(s) for which it is identifying preemptable boundaries. Alternatively, boundary identification process 500 may be employed at runtime in the context of the same embedded system(s) for which the preemptable boundaries are sought. This may be especially useful in situations where layer statistics experience drift or otherwise vary over time.

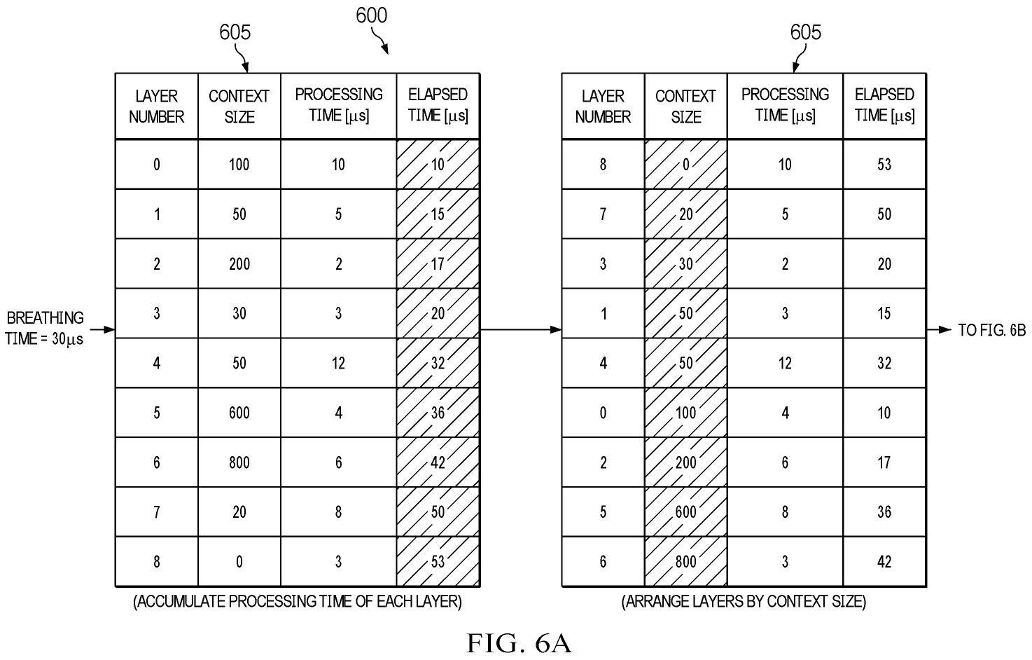

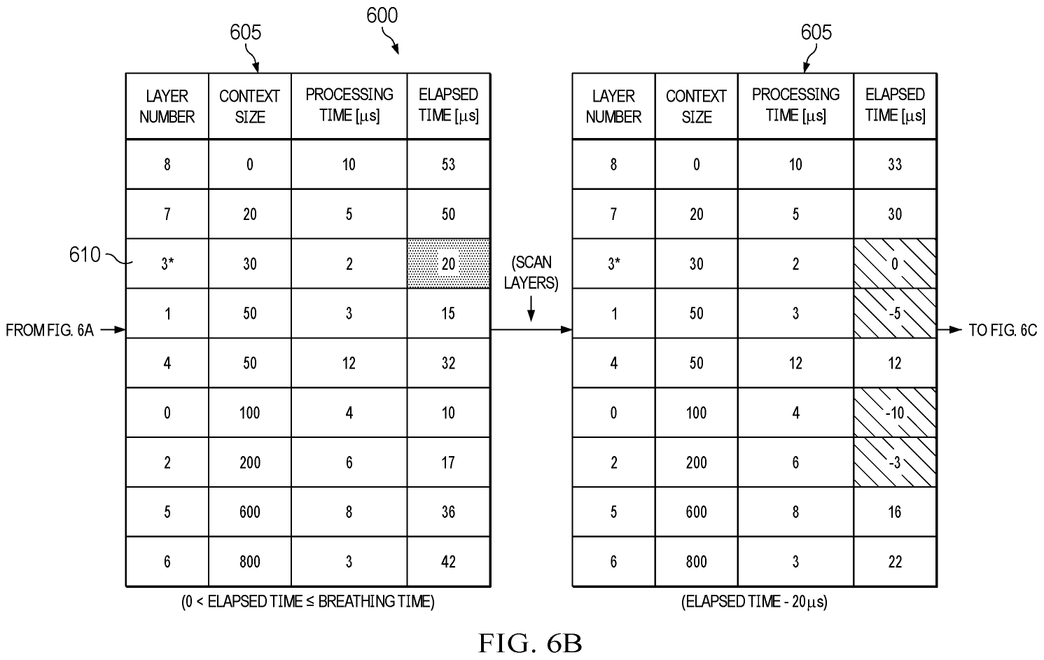

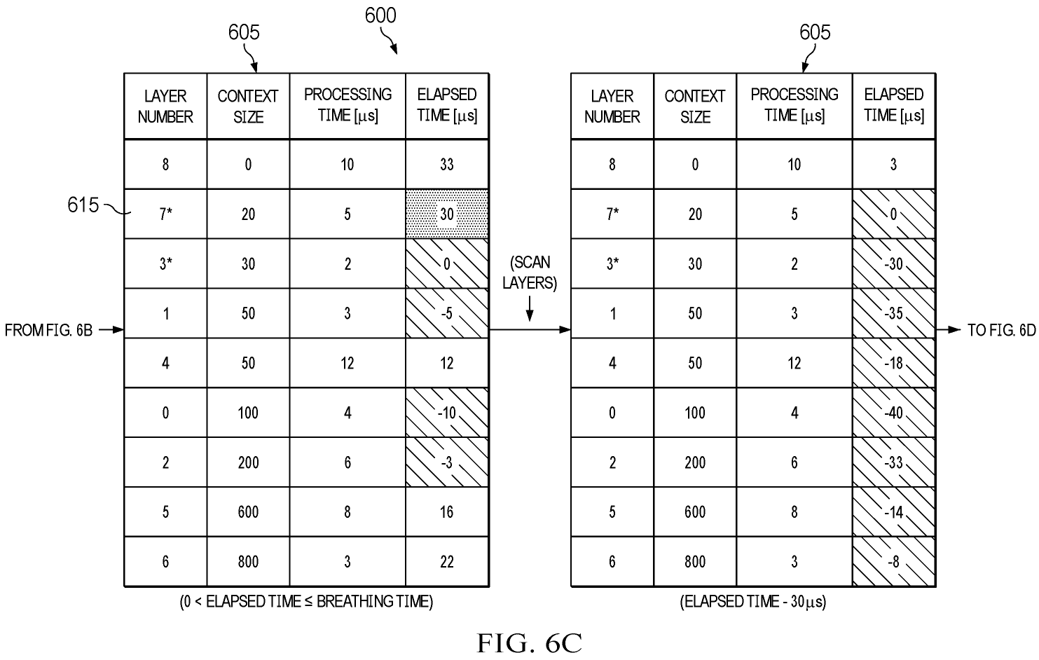

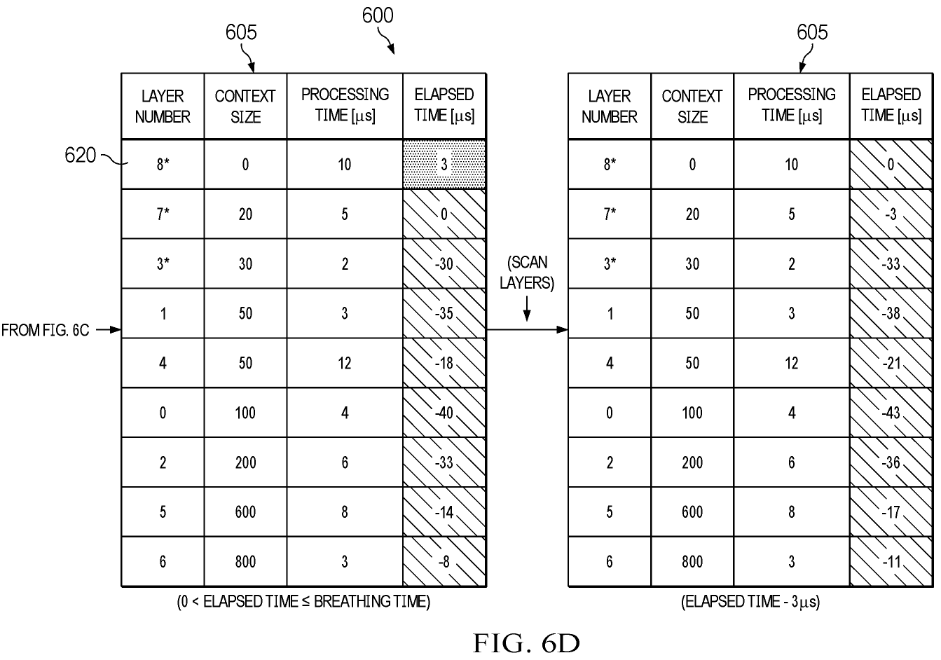

FIGS. 6A-6D illustrate a visualization of an application of boundary identification process 500 system. Beginning with FIG. 6A, visualization 600 includes table 605. Table 605 represents layer statistics corresponding to a DNN of the multi priority DNN system. Table 605 may include a layer number, a context size, a processing time [μs], and an elapsed time [μs] of each layer within the corresponding DNN.

In a first step, a suitable computing device employing boundary identification process 500 identifies a breathing time related to a higher priority DNN relative to the priority or the target DNN. As discussed earlier, the breathing time of the multi priority DNN system is equal to the difference between the tolerable latency time and the execution time of the higher priority DNN within the system. For the purposes of this example, the breathing time of visualization 600 is equal to 30 μs. 30 μs is just one example of a possible breathing time; other durations may be used for breathing time, depending on the characteristics of a computing device and/or neural network.

Once identified, the computing device accumulates the processing times of each layer sequentially, to determine the elapsed time of each layer. The elapsed time of a layer accounts for the time taken to execute previous layers. For example, the elapsed time to execute layer 4 of the represented DNN equals the summed processing times of layers 0, 1, 2, 3, and 4 respectively.

Next the computing device reorders the layers within table 605 based on the context size of each layer. In an implementation, the processor reorders layers from smallest context size to largest context size. For example, layer 8 will come first in table 605, while layer 6 will come last, because layer 8 has the smallest context size while layer 6 has the largest context size.

In FIG. 6B, visualization 600 displays the iterative process of identifying preemptable boundaries within the represented DNN. In a first step, the computing device scans the reordered layers to identify a first layer with an elapsed time that is less than or equal to the identified breathing time, 30 μs, but greater than 0 μs. As displayed by table 605, layer 3 is the first layer to have an elapsed time that is less than or equal to 30 μs, but greater than 0 μs. As such, the computing device identifies preemptable boundary 610 as the first preemptable boundary of the represented DNN such that preemptable boundary 610 exists after layer 3.

Next, the computing device reduces the elapsed time of each layer within table 605 by the elapsed time of layer 3 (20 μs) to determine whether more preemptable boundaries exist within the represented DNN. If table 605 displays a layer with an elapsed time greater than 0 μs, then, more preemptable boundaries exist within the represented DNN. Else, the computing device has identified all the preemptable boundaries of the represented DNN. As displayed by table 605, layers 8, 7, 4, 5, and 6 have an elapsed time greater than 0 μs, and thus may be preemptable.

In FIG. 6C, visualization 600 displays a next iteration of the iterative process to identify preemptable boundaries. In a first step, the computing device rescans the updated layers to identify a next layer with an elapsed time that is less than or equal to 30 μs but greater than 0 μs. As displayed by table 605, layer 7 is the next layer to have an elapsed time that is less than or equal to 30 μs. As such, the computing device identifies preemptable boundary 615 as the next preemptable boundary of the represented DNN such that preemptable boundary 615 exists after layer 7.

Next, the computing device reduces the elapsed time of each layer within table 605 by the elapsed time of layer 7 (30 μs) to determine whether more preemptable boundaries exist within the represented DNN. As displayed by table 605, layer 8 is the only remaining layer to have an elapsed time greater than 0 μs, and thus may be preemptable.

In FIG. 6D, visualization 600 displays a final iteration of the iterative process to identify preemptable boundaries. In a first step, the computing device rescans the updated layers to identify the next layer with an elapsed time that is less than or equal to 30 μs but greater than 0 μs. As displayed by table 605, layer 8 is the only layer to have an elapsed time that is less than or equal to 30 μs but greater than 0 μs. As such, the computing device identifies preemptable boundary 620 as the final preemptable boundary of the represented DNN such that preemptable boundary 620 exists after layer 8.

Finally, the computing device reduces the elapsed time of each layer within table 605 by the elapsed time of layer 8 (3 μs). As there are no layers with an elapsed time greater than 0 μs the processor determines that all available preemptable boundaries of the represented DNN have been identified. As such, the computing device identifies preemptable boundaries 610, 615, and 620 as allowable points to preempt the represented DNN during execution.

FIG. 7 illustrates computing system 701 that represents any system or collection of systems in which the various processes, programs, services, and scenarios disclosed herein may be implemented. Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements process 706, which is (are) representative of the processes discussed with respect to the preceding Figures, such as scheduling process 200 and boundary identification process 500. When executed by processing system 702, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 comprises a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 comprises any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including process 706) may be implemented in program instructions and among other functions may, when executed by processing system 702, direct processing system 702 to operate as described with respect to the various operational scenarios, sequences, and processes illustrated herein. For example, software 705 may include program instructions for implementing a model scheduling process as described herein, and/or a boundary identification process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to support the execution of inference models in an optimized manner. Encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
determining an interrupt flag has been set indicative of a request to interrupt execution of a first inference model in favor of a second inference model;
in response to determining that the interrupt flag has been set, determining a state of the execution of the first inference model based on one or more factors; and
in response to determining the state of the execution is at a preemptable boundary, deactivating the first inference model and activating the second inference model.

2. The method of claim 1 wherein the one or more factors includes a time to reach the preemptable boundary of the first inference model relative to an allowable breathing time of the first inference model.

3. The method of claim 2 wherein:
the first inference model includes multiple layers; and
the preemptable boundary includes a boundary between a most recently completed layer of the inference model and a next layer of the inference model.

4. The method of claim 3 further comprising identifying preemptable boundaries of the first inference model based on performance characteristics of each of the multiple layers of the first inference model and the allowable breathing time for the first inference model.

5. The method of claim 4 wherein the performance characteristics include a context size and a processing time of each of the multiple layers.

6. The method of claim 4 wherein the breathing time comprises a difference between an execution time of the second inference model and a tolerable latency of the second inference model.

7. The method of claim 1 further comprising re-activating the first inference model after completion of the second inference model.

8. A computing apparatus comprising:
one or more computer-readable storage media;
one or more processors operatively coupled with the one or more computer-readable storage media; and
program instructions stored on the one or more computer-readable storage media that, when executed by the one or more processors, direct the computing apparatus to at least:
determine that an interrupt flag has been set indicative of a request to interrupt execution of a first inference model in favor of a second inference model;
in response to determining that the interrupt flag has been set, determine a state of the execution of the first inference model based on one or more factors; and
in response to determining the state of the execution is at a preemptable boundary, deactivate the first inference model and activate the second inference model.

9. The computing apparatus of claim 8 wherein the one or more factors include a time to reach the preemptable boundary of the first inference model relative to an allowable breathing time of the first inference model.

10. The computing apparatus of claim 9 wherein:
the first inference model includes multiple layers; and
the preemptable boundary includes a boundary between a most recently completed layer of the inference model and a next layer of the inference model.

11. The computing apparatus of claim 10 wherein the program instructions further direct the computing apparatus to identify preemptable boundaries of the first inference model based on performance characteristics of each of the multiple layers of the first inference model and the allowable breathing time for the first inference model.

12. The computing apparatus of claim 11 wherein the performance characteristics include a context size and a processing time of each of the multiple layers.

13. The computing apparatus of claim 11 wherein the breathing time comprises a difference between an execution time of the second inference model and a tolerable latency of the second inference model.

14. The computing apparatus of claim 8 further comprising program instructions that direct the processing unit to re-activate the first inference model upon completion of the second inference model.

15. An embedded system comprising:
a sensor interface configured to receive input data from an array of sensors and set interrupt flags to indicate the arrival of the input data; and
a processor configured to at least:
determine that an interrupt flag has been set indicative of a request to interrupt execution of a first inference model in favor of a second inference model;
in response to determining that the interrupt flag has been set, determine a state of the execution of the first inference model based on one or more factors; and
in response to determining the state of the execution is at a preemptable boundary, deactivate the first inference model and activate the second inference model.

16. The embedded system of claim 15 wherein the one or more factors include a time to reach the preemptable boundary of the first inference model relative to an allowable breathing time of the first inference model.

17. The embedded system of claim 16 wherein:
the first inference model includes multiple layers; and
the preemptable boundary includes a boundary between a most recently completed layer of the inference model and a next layer of the inference model.

18. The embedded system of claim 17 wherein the controller is further configured to identify preemptable boundaries of the first inference model based on performance characteristics of each of the multiple layers of the first inference model and an allowable breathing time for the first inference model.

19. The embedded system of claim 18 wherein the performance characteristics include a context size and a processing time of each of the multiple layers.

20. The embedded system of claim 15 wherein the processor is further configured to activate the second inference model after an allotted duration.
